(19) United States
(12) Patent Application Publication
(10) Pub. No.: US 2022/0194819 A1
(43) Pub. Date: Jun. 23, 2022

(54) IN-LINE WATER HARDNESS SENSOR AND WATER SOFTENER CONTROL SYSTEM

(71) Applicant: A. O. SMITH CORPORATION, Milwaukee, WI (US)

(72) Inventors: Di Zhao, Pleasant Prairie, WI (US); Yizhi Hou, Milwaukee, WI (US)

(21) Appl. No.: 17/604,280

(22) PCT Filed: May 16, 2019
(86) PCT No.: PCT/US2019/032577

§ 371 Date: Oct. 15, 2021

(51) Int. Cl. C02F 1/42; C02F 1/44; B01J 49/75; B01J 49/85; B01D 61/02

(52) U.S. Cl. CPC C02F 1/42; C02F 1/442; B01J 49/75; B01J 49/85; C02F 2307/10; C02F 2001/425; C02F 2209/055; C02F 2209/40; C02F 2307/06; B01D 61/027

(57) ABSTRACT

A water softener regeneration system for a water softener configured to soften and filter water, the regeneration system includes a water hardness measurement system configured to determine a hardness value of water flowing out of the water softener. A brine tank is in communication with the water softener and operable to regenerate the water softener with brine from the brine tank. A controller is operable to control the brine tank, wherein the controller actuates by one of opening and closing the brine tank based on the hardness value which is indicative of the effectiveness of the water softener.

### BACKGROUND

The present invention relates to systems and methods for using an in-line water hardness sensor and water softener control system.

The hardness of water is mainly caused by the presence of calcium and magnesium ions in water. In salt-based water softeners, ion-exchange resins are used to replace the calcium and magnesium ions with sodium ions. When the ion-exchange resin is fresh, it contains a large concentration of sodium ions at its active sites and can produce well-softened water. During usage, sodium ions in the ion-exchange resin are gradually replaced by calcium and magnesium ions and eventually, the resin beads become saturated. When the resin beads have reached exhaustion, the hardness level in product water will greatly increase and the water softener must be regenerated.

Monitoring of product water's hardness level is important to control the operation of water softeners. When the ion-exchange resin does not have enough capacity to produce well softened water, the product water's hardness will increase, and the water softener needs to be regenerated as soon as possible. Currently, most of the commercially available hardness measurement technologies are either based on ion selective electrode (ISE) or ethylenediaminetetraacetic acid (EDTA) titration methods. Those instruments are either very expensive or inconvenient. Therefore, there are few water softener products in the market which use the ISE calcium ion sensor or auto-titrator to control the regeneration process. Those water softeners are expensive and the users must recalibrate the ISE or change the titration reagents frequently to ensure the hardness sensor's reliability.

### SUMMARY

In one embodiment, the invention provides a water softener regeneration system for a water softener configured to soften and filter water, the regeneration system including a water hardness measurement system configured to determine a conductivity value of water flowing out of the water softener, a brine tank in communication with the water softener and operable to regenerate the water softener with brine from the brine tank, and a controller operable to control the brine tank, wherein the controller actuates by one of opening and closing the brine tank based on the hardness value which is indicative of the effectiveness of the water softener

In another embodiment the invention provides a method for determining when a water softener configured to soften water needs to be regenerated, the method including operating the water softener to soften the water, operating a first sensor to measure a first conductivity value of the water in the water softener and a nanofiltration module, operating a second sensor to measure a second conductivity value of the water between the nanofiltration module and an exit port, operating a controller to implement an algorithm to determine a hardness value of the water in the water softener from the first and second conductivity values, operating the controller to compare the measured hardness value to a predetermined value, and regenerating the water softener in response to a command from the controller when the measured hardness value exceeds the predetermined value.

In another embodiment the invention provides a method for determining when a brine tank in communication with the water softener needs to be refilled, wherein the water softener is configured to soften and filter a water supply, the method including operating a flowmeter configured to measure a first volume of water softened by the water softener, operating a first sensor to measure a first conductivity value of the water between the water softener and the nanofiltration module, operating a second sensor to measure a second conductivity value between the nanofiltration module and an exit port, operating a controller to implement an algorithm to determine a hardness value of the water in the water softener from the first and second conductivity values, comparing the measured hardness value to a predetermined hardness value, operating the flowmeter to determine a first volume value of water softened prior to the measured hardness value exceeding the predetermined value, after determining the first volume, regenerating the water softener, after regenerating, operating the flowmeter to measure a second volume value of water softened after regeneration and prior to the measured hardness value exceeding the predetermined hardness value, and refilling the brine tank with salt if the second volume value is less than a predetermined percentage of the first volume, and regenerating the water softener if the second volume value is not less than the predetermined percentage of the first volume value.

Other aspects of the invention will become apparent by consideration of the detailed description and accompanying drawings.

### BRIEF DESCRIPTION OF THE DRAWINGS

FIG. 1 is a schematic representation of a water softener system having a hardness sensor for inline hardness measurement.

FIG. 2 is a schematic representation of the water softener system of FIG. 1 according to an alternative embodiment of the invention.

FIG. 3 is a schematic representation of an alternative water softener system having a hardness sensor for inline hardness measurement.

FIG. 4 is a representation of a control system for use with a water softener system.

FIG. 5 is a flowchart of a process of automatically regenerating a water softener.

FIG. 6 is a flowchart of a process of determining when a brine tank needs to be regenerated.

FIG. 7 is a perspective view of a nanofiltration module in the water softener systems illustrated in FIGS. 1-2.

FIG. 8 is an exploded perspective view of the nanofiltration module of FIG. 7.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

The present invention relates to a system and method of monitoring effectiveness of a water softener. The water softener in the present invention is an ion-exchange resin which softens water by removing ions that contribute to water hardness, such as calcium and magnesium, and replacing the ions with sodium to generate “softened water.” The invention employs a water hardness monitoring system to continuously or periodically check the non-sodium ion content of the softened water. A rise in non-sodium ion content downstream of the water softener is an indication that the ion-exchange resin is losing its effectiveness to soften the water.

There are multiple ways and configurations for implementing a water hardness monitoring system according to the present invention, but the fundamental concept or method is to measure conductivity of the softened water, remove sodium ions from the softened water (to create filtered water or “permeate”), and measure conductivity of the permeate. Specifically, a nanofiltration module filters a portion of the softened water to remove sodium ions. If the ion-exchange resin is effectively softening the water, the conductivity of the softened water should mainly arise from the presence of sodium ions in the softened water. That being the case, the conductivity of the permeate should be very low compared to the conductivity of the softened water.

If, however, the ion-exchange resin is losing or has lost its effectiveness, non-sodium ions such as calcium and magnesium ions will pass through the water softener. The loss of effectiveness of the ion-exchange resin can be referred to as “breakthrough” of the resin. As the ion-exchange resin loses its effectiveness, the conductivity of the softened water will increasingly be attributable to the non-sodium ions in the softened water. As noted above, the water hardness monitoring system of the present invention removes sodium ions from the softened water, but does not effectively remove non-sodium ions from the softened water. Consequently, as breakthrough occurs, the conductivity of the permeate will be closer to the conductivity of the softened water. The water hardness monitoring system of present invention compares the conductivity of the softened water to the conductivity of the permeate to determine whether breakthrough is happening at the water softener.

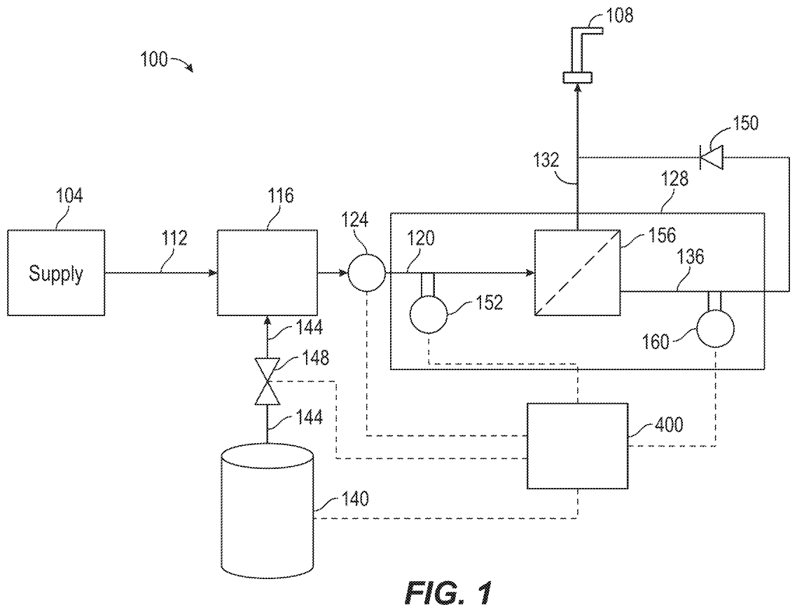

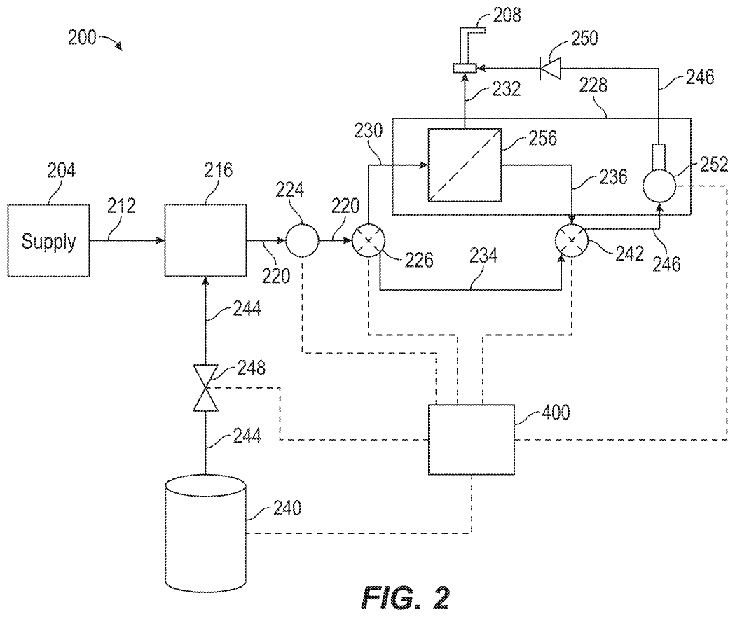

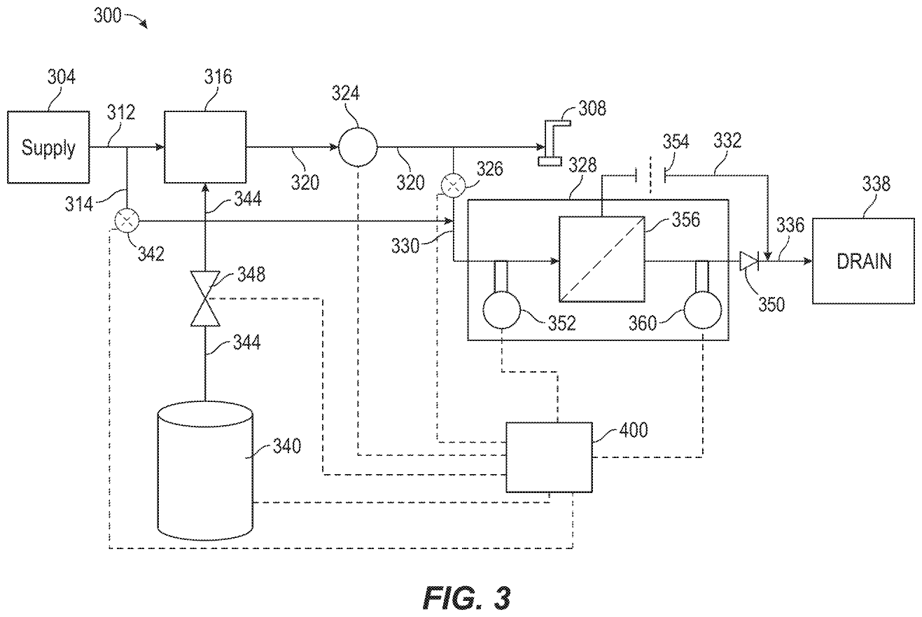

The water hardness monitoring system of the present invention uses a nanofiltration module to filter sodium ions from the softened water. The nanofiltration module is not capable of removing non-sodium ions such as calcium and magnesium efficiently. The invention contemplates several configurations for sensing conductivity of the softened water and permeate. In two configurations (FIGS. 1 and 3), a first conductivity sensor is positioned upstream of the nanofiltration module to sense conductivity of the softened water and a second conductivity sensor is positioned downstream of the nanofiltration module to sense conductivity of the permeate. In another configuration (FIG. 2), a single conductivity sensor alternately receives and measures conductivity of softened water and permeate. The nanofiltration module has different permeabilities to monovalent ions (e.g., Na⁺, K⁺, etc.) and divalent ions (e.g., Ca²⁺, Mg²⁺, etc.) Therefore, in alternative embodiments, the nanofiltration module may be capable of removing hardness in the water and enabling the passage of sodium ions. For example, the DOW FILMTEC™ NF270 membrane has a relatively higher permeability to calcium and magnesium ions than sodium ions. There are other configurations and variations on using a nanofiltration module and one or more conductivity sensors and the examples given in this disclosure should not be regarded as limiting of the invention. In some configurations (FIG. 3), the water hardness monitoring system may be used to monitor the hardness level of raw water when an inlet of the hardness monitor system is connected to a feed line of the raw water supply.

In addition to the water hardness monitoring system, the present invention provides system logic for regenerating the resin in the water softener when breakthrough is determined by introducing into the water softener sodium ions in the form of brine from a brine tank. The brine draws its sodium ion content from salt in the brine tank. As the salt is depleted and/or consumed with each regeneration cycle, the brine loses its sodium ion content. The invention provides a system for monitoring the effectiveness of the brine (i.e., its sodium ion content) by monitoring the volume of water passing out of the water softener between regeneration cycles. As the salt becomes more and more depleted, the rate of change (i.e., the rate of decrease) in volume of softened water produced by the water softener between regeneration cycles becomes more severe. When the rate of change reaches a critical level (i.e., volume of softened water produced by the water softener in the current cycle is significantly less than the volume of water produced in the previous cycle), the system determines that the salt in the brine tank has become unacceptably depleted and calls for the salt to be replenished.

FIG. 1 schematically represents a water softener system 100. The system 100 receives water (called “feed water”) from a water supply (e.g., a raw water supply) 104 which may be a municipal water supply, a well or any other typical source of potable water, and delivers clean, softened water to a potable water output device such as a faucet, or exit port, 108. The feed water may be provided under typical head pressures for water supply systems. The water supply 104 and faucet 108 are illustrated schematically and are intended to include any water inlet and any water outlet of the system 100.

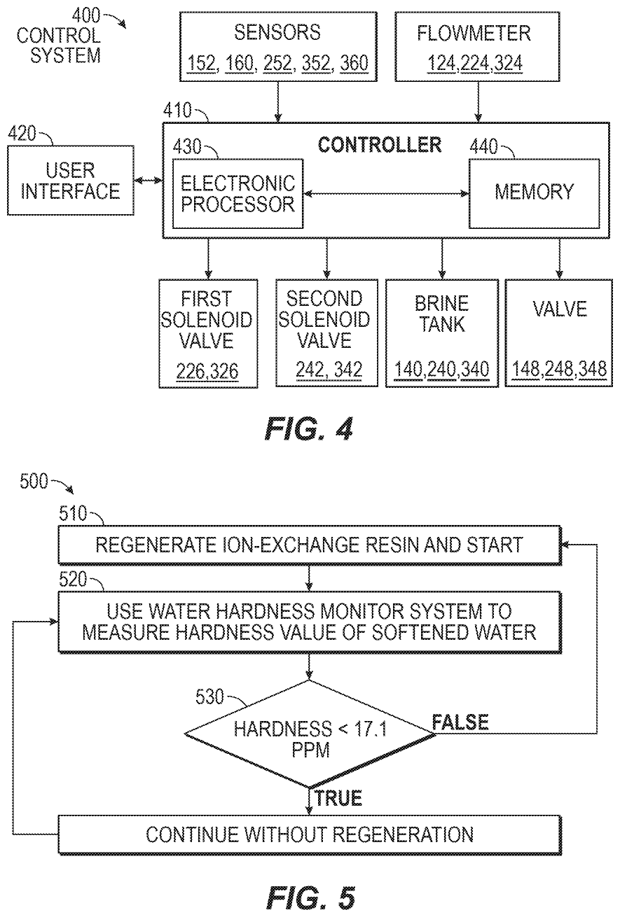

The major components of the system 100 include: a feed line 112, an ion-exchange reactor 116, a softened water line 120, a flowmeter 124, a water hardness monitor system 128, a drain line 132, a permeate line 136, a check valve 150, a brine tank 140, a brine supply line 144, a valve 148, and a control system 400. The water hardness monitor system 128 includes a first sensor 152, a nanofiltration module 156, and a second sensor 160. The control system 400 includes a controller 410 (FIG. 4) and control logic to coordinate operation of the various other components. The specific control logic will be addressed after the following description of the major components.

The feed line 112 communicates between the water supply 104 and the ion-exchange reactor 116. The ion-exchange reactor 116 includes an upstream side communicating with the feed line 112 and a downstream side communicating with the softened water line 120. The ion-exchange reactor 116 includes an ion-exchange resin which removes impurities that contribute to water hardness, such small dissolved solids and ions (e.g., calcium, magnesium), thereby creating “softened water” that is delivered to the softened water line 120.

The softened water line 120 communicates with the downstream side of the ion-exchange reactor 116. The flowmeter 124 is in the softened water line 120 downstream of the reactor 116 and communicates (either via wires or wirelessly) the flow rate and volume of the softened water to the controller 410. The flowmeter 124 may be positioned, for example, immediately downstream of the reactor 116 and upstream of the first sensor 152, as illustrated. In alternative configurations, the flowmeter 124 could be positioned anywhere along the softened water line 120. The flowmeter 124 may also be separately removable from the system 100, allowing the flowmeter 124 to be individually replaced in the event of damage.

The first sensor 152 is in the softened water line 120 downstream of the flowmeter 124 and communicates with the controller 410 to monitor conductivity of the softened water. The conductivity of the softened water arises from impurities (e.g., total dissolved solids including but not limited to sodium ions, calcium ions, and magnesium ions) in the softened water. Specifically, the first sensor 152 determines a first conductivity value C1 of the softened water and communicates (either via wires or wirelessly) the value C1 to the controller 410. Although preferably positioned immediately downstream of the ion-exchange reactor 116, the first sensor 152 can be positioned anywhere along the softened water line 120. In the preferred construction, the first sensor 152 may be a conductivity sensor and/or total dissolved solids (e.g., TDS) sensor, but other types of sensors may be used to sense TDS concentration of the softened water line 120. The first sensor 152 may be separately removable from the system 100, allowing the first sensor 152 to be individually replaced in the event of damage.

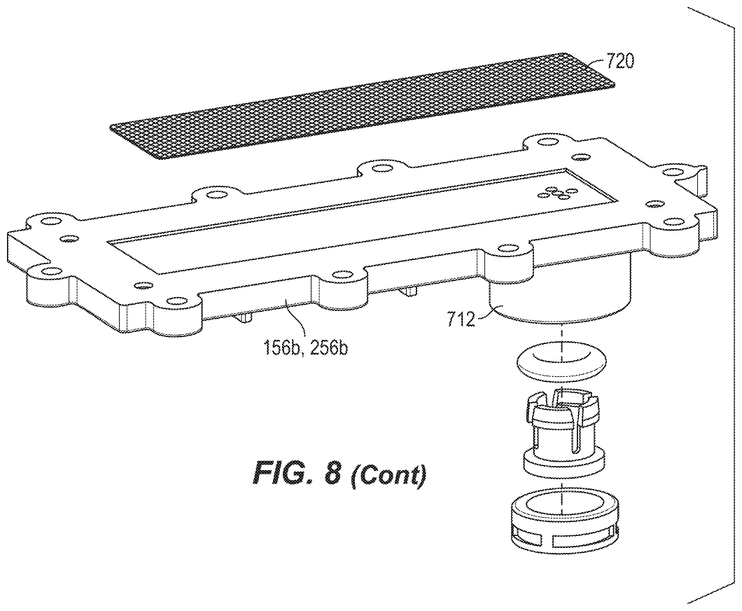

The softened water line 120 communicates between the ion-exchange reactor 116 and the nanofiltration module 156. The nanofiltration module 156 includes an upstream side communicating with the softened water line 120 and the drain line 132, and a downstream side communicating with the permeate line 136. The nanofiltration module 156 includes a nanofiltration membrane 158 (FIG. 8) that has different permeabilities to monovalent ions (e.g., Na⁺, K⁺, etc.) and divalent ions (e.g., Ca²⁺, Mg²⁺, etc.). Water containing the sodium ions and other impurities is delivered to the drain line 132 on the upstream side of the nanofiltration membrane 158. Water that passes through the nanofiltration membrane 158 (referred to as “permeate”) is delivered to the permeate line 136 on the downstream side. In alternative embodiments, the nanofiltration module 156 may be capable of removing hardness in the water and enabling the passage of sodium ions. For example, the DOW FILMTEC™ NF270 membrane has a relatively higher permeability to calcium and magnesium ions than sodium ions.

The permeate line 136 communicates with the downstream side of the nanofiltration module 156. The second sensor 160 is in the permeate line 136 downstream of the nanofiltration module 156 and communicates with the controller 410 to monitor the conductivity of the permeate. The check valve 150 is positioned in the permeate line 136 to prevent water from flowing from the drain line 132 to the permeate line 136. The check valve 150 may additionally be a part of a multiport softener control valve, such as those manufactured by Hague Quality Water. Because sodium ions are effectively removed from the water by the nanofiltration membrane 158, the conductivity of the permeate arises mainly from the presence of non-sodium ions such as calcium and magnesium ions. Specifically, the second sensor 160 determines a second conductivity value C2 of the permeate and communicates (either via wires or wirelessly) the second conductivity value C2 to the controller 410. Although preferably positioned immediately downstream of the nanofiltration module 156, the second sensor 160 can be positioned anywhere along the permeate line 136 and upstream of the check valve 150. In the preferred construction, the second sensor 160 may be a conductivity sensor and/or TDS sensor, but other types of sensor may be used to sense the concentration of TDS in the permeate. The second sensor 160 may be separately removable from the system 100, allowing the second sensor 160 to be individually replaced in the event of damage.

The water hardness monitor system 128 permits the control system 400 to monitor and compare conductivity of the softened water and conductivity of the permeate to determine whether there has been breakthrough in the ion-exchange resin. More specifically, the first and second sensors 152, 160 communicate the first and second conductivity values C1, C2 to the controller 410. The controller 410 implements a first algorithm, shown below, to determine an ion rejection rate S using the first and second conductivity values C1, C2.

$$S ( \% ) = 100 \times ( 1 - \frac{C 2}{C 1} )$$

The value (C2/C1) is the ratio of the conductivity of the permeate to the conductivity of the softened water. This ratio, which is less than one, will become larger (i.e., approach 1) as conductivity becomes more and more attributable to non-sodium ions due to breakthrough of the resin in the ion exchange reactor 116. As this ratio increases, the ion rejection rate S decreases.

The decline of ion rejection rate S signifies a change in water hardness. As the ion-exchange resin experiences breakthrough, a hardness value H of the softened water increases from zero and the second conductivity value C2 increases. For example, if the ion-exchange resin is fully intact, the hardness of the softened water is substantially 0 ppm with a first conductivity value C1 of approximately 312.20, and the permeate has a second conductivity value C2 of approximately 13.5 μS. Therefore, the conductivity rejection rate of the nanofiltration module 156 is approximately 95.7%. However, as the ion-exchange resin experiences breakthrough, the hardness of the softened water increases. For example, if the ion-exchange resin is completely exhausted, the hardness of the feed water will be equal to the hardness of the softened water (e.g., 133 ppm), and the first conductivity value C1 of the softened water will remain the same or only slightly decrease (e.g., 299.7 μS). However, the conductivity value C2 of the permeate will greatly increase (e.g., 91.1 μS). As such, the rejection rate S substantially decreases to approximately 69.5%. The controller 410 will alert the user that the ion-exchange resin has experienced significant breakthrough and needs to be regenerated and/or recharged with brine (e.g., salt), or the controller will automatically regenerate the ion-exchange resin. Additionally, as described in greater detail below, the controller 410 may open the valve 148 and actuate the brine tank 140 to direct brine from the tank 140 to the ion-exchange resin.

The water hardness monitor system 128 may be calibrated with water samples of different hardness values to obtain a specific correlation between the ion rejection rate S, the first conductivity value C1, the second conductivity value C2, and the hardness value H. The water hardness monitor system 128 may further be automatically corrected after each regeneration cycle by using fully softened water (e.g., water with a hardness of 0 ppm) as a baseline calibration water sample. In the illustrated embodiment, the sensors 152, 160 sense the hardness of the water at a first state in which the water is flowing. In alternative embodiments, the sensors 152, 160 may additionally sense the hardness of the water at a second state in which the water is stagnant.

The brine tank 140 may take the form of any receptacle or vessel which can store brine (e.g., sodium ions) for recharging the ion-exchange resin. In this regard, the term “tank” is intended to be a very broad term encompassing all such receptacles and vessels. The brine in the brine tank 140 may be generated, for example, from salt immersed in water in the brine tank 140. As will be discussed below, each regeneration cycle of the reactor 116 depletes the salt in the brine tank 140. The brine tank 140 is controlled by the controller 410. More specifically, the controller 410 actuates the brine tank 140 (e.g., opens communication between the tank 140 and the reactor 116) to supply a flow of brine to the ion-exchange reactor 116 via the brine supply line 144. Brine may move through the brine supply line 144 via a vacuum generated by an educator. In alternative embodiments, brine may move through the brine supply line 144 due to head pressure or under the influence of a pump, or a user may manually actuate the brine tank 140 to supply a flow of brine to the ion-exchange reactor 116.

The brine supply line 144 communicates with the brine tank 140 and the ion-exchange reactor 116. More specifically, the brine supply line 144 delivers brine provided within the brine tank 140 to the ion-exchange reactor 116 when the ion-exchange resin needs to be regenerated. The valve 148 is in the brine supply line 144 downstream of the brine tank 140 and upstream of the ion-exchange reactor 116. The valve 148 is controlled by the controller 410 to open and/or close, permitting and/or preventing the flow of brine from the brine tank 140 to the ion-exchange reactor 116 via the brine supply line 144.

With continued reference to FIG. 1, the mode of operation of the system 100 (in which the user draws water from the system 100 via the faucet 108) will now be described. The instant the faucet 108 is open, water moves from the water supply 104 through the ion-exchange reactor 116 via the feed line 112. Softened water flows toward the nanofiltration module 156 via the softened water line 120. The flowmeter 124 determines the flow rate and volume of softened water and communicates the flow rate and volume value to the controller 410. Similarly, the first sensor 152 determines the first conductivity value C1 of the softened water and communicates the first conductivity value C1 to the controller 410. The softened water then flows into the nanofiltration module 156. Permeate flows out of the nanofiltration module 156 via the permeate line 136. The second sensor 160 determines the second conductivity value C2 of the permeate and communicates the second conductivity value C2 to the controller 410. Impurities caught in the upstream side of the nanofiltration module 156 flow through the drain line 132 and are combined with the permeate downstream of the second sensor 160 to recreate the softened water, which is delivered to the faucet 108 for consumption.

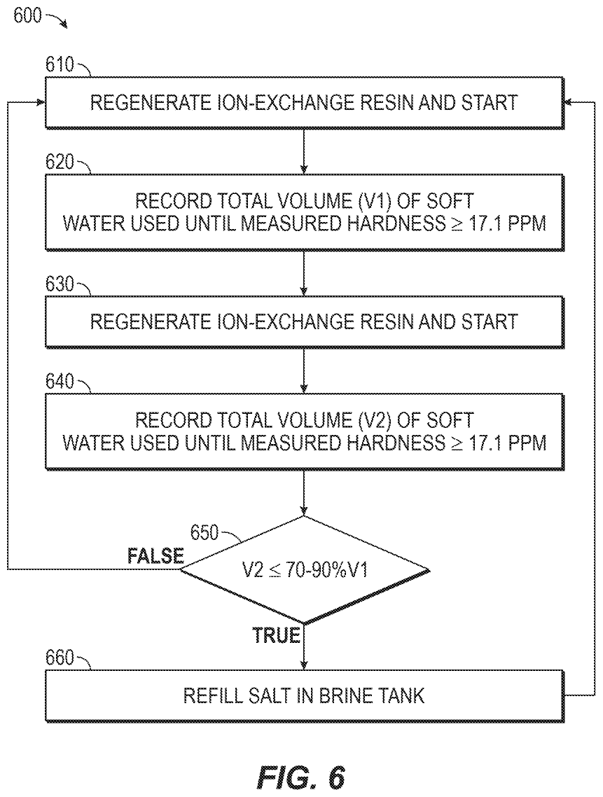

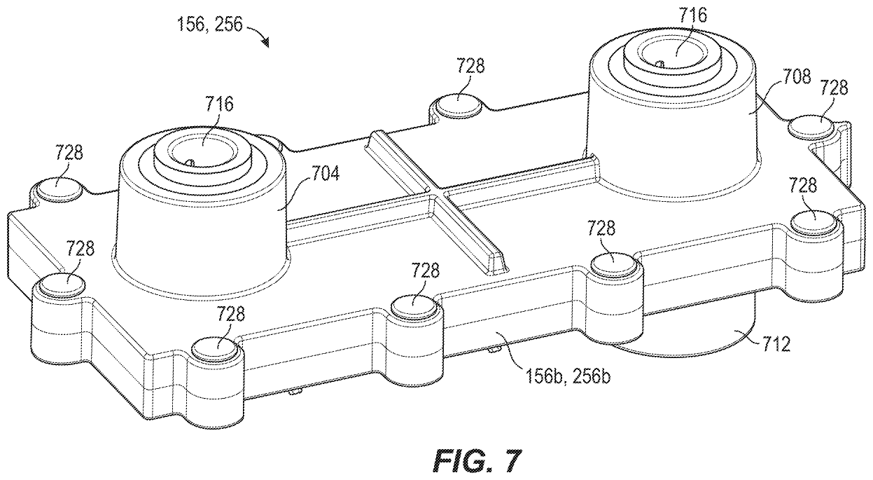

The controller 410 uses the flow rate, volume value, and the conductivity values C1, C2 to monitor and operate the brine tank 140, as will be described below with reference to FIGS. 5-6. Based on the communication between the controller 410 and the brine tank 140, the controller 410 may open the valve 148 and actuate the brine tank 140, which permits the flow of brine from the brine tank 140 to the ion-exchange resin via the brine supply line 144.

FIG. 2 illustrates an alternative softener system 200. The illustrated system 200 is similar to the system 100 described above and includes like parts. The system 200 differs from the system 100 in how conductivity is monitored, which will be described below. Components that are similar to those described in the system 100 have the same reference number plus “200.”

The system 200 receives water (called “feed water”) from a water supply (e.g., a raw water supply) 204 which may be a municipal water supply, a well or any other typical source of potable water, and delivers clean, purified water to a potable water output device such as a faucet, or exit port, 208. The feed water may be provided under typical head pressures for water supply systems. The water supply 204 and faucet 208 are illustrated schematically and are intended to include any water inlet and any water outlet of the system 200.

The major components of the system 200 include: a feed line 212, an ion-exchange reactor 216, a softened water line 220, a flowmeter 224, a first three-way valve 226, a water hardness monitor system 228, a filtration line 230, a drain line 232, a bypass line 234, a permeate line 236, a second three-way valve 242, a check valve 250, an exit line 246, a brine tank 240, a brine supply line 244, a valve 248, and the control system 400. The water hardness monitor system 228 includes a first sensor 252 and a nanofiltration module 256. The control system 400 includes the controller 410 and control logic to coordinate operation of the various other components. The specific control logic will be addressed after the following description of the major components.

The feed line 212 communicates between the water supply 204 and the ion-exchange reactor 216. The ion-exchange reactor 216 includes an upstream side communicating with the feed line 212 and a downstream side communicating with the softened water line 220. The ion-exchange reactor 216 includes an ion-exchange resin which removes impurities that contribute to water hardness, such as small dissolved solids (e.g., calcium, magnesium), thereby creating the softened water line 220. The water on the downstream side has a lower concentration of impurities and may be referred to as “softened water.”

The softened water line 220 communicates with the downstream side of the ion-exchange reactor 216. The flowmeter 224 is in the softened water line 220 downstream of the reactor 216 and communicates (either via wires or wirelessly) with the controller 410 to monitor the flow rate and volume of softened water. The flowmeter 224 may be positioned, for example, immediately downstream of the reactor 216 and upstream of the first sensor 252 as illustrated. In alternative configurations, the flowmeter 224 could be positioned anywhere along the softened water line 220. The flowmeter 224 may also be separately removable from the system 200, allowing the flowmeter 224 to be individually replaced in the event of damage.

The first three-way valve 226 is in the softened water line 220 downstream of the flowmeter 224 and directs the flow of softened water. Specifically, the first three-way valve 226 may direct the softened water to flow through the filtration line 230 or through the bypass line 234. The first three-way valve 226 is in communication with the controller 410. The controller 410 emits a signal to the three-way valve 226 to direct the flow of softened water into the filtration line 230 or the bypass line 234. The direction of the flow may be based on volume, flow rate, time, etc. In some embodiments, the three-way valve 226 may be a solenoid valve.

When the softened water is directed into the filtration line 230, the water flows toward the nanofiltration module 256. The filtration line 230 communicates between the first three-way valve 226 and the nanofiltration module 256. The nanofiltration module 256 includes an upstream side communicating with the filtration line 230 and the drain line 232, and a downstream side communicating with the permeate line 236. The nanofiltration module 256 includes a nanofiltration membrane 258 performs the same function a nanofiltration membrane 158 discussed above. The permeate exits the nanofiltration module 256 via the permeate line 236. Specifically, the permeate line 236 communicates between the nanofiltration module 256 and the second three-way valve 242.

When the water is directed into the bypass line 234, the water flows directly from the first three-way valve 226 to the second three-way valve 242, allowing the softened water to bypass additional filtration from the nanofiltration module 256. When the water reaches the second three-way valve 242, the valve 242 may permit the flow of water into the exit line 246. The controller 410 communicates with the second three-way valve 242 to send a signal to redirect the water through the valve 242. The water is then directed through the second three-way valve 242 and into the exit line 246. In some embodiments, the three-way valve 242 may be a solenoid valve.

The first sensor 252 is in the exit line 246 downstream of the second three-way valve 242 and communicates with the controller 410 to monitor conductivity of the water in the exit line 246. The water in the exit line 246 may be softened water or permeate depending on the settings of the first and second three-way valves 226, 242. The check valve 250 is positioned in the exit line 246 to prevent water from flowing from the drain line 232 to the exit line 246. The check valve 250 may additionally be a part of a multiport softener control valve, such as those manufactured by Hague Quality Water. When the water passes through the sensor 252, the sensor 252 determines a conductivity value of the water and communicates (either via wires or wirelessly) the conductivity value to the controller 410. The controller 410 then records the conductivity value as a first conductivity value C1 (if softened water from the bypass line 234) or a second conductivity value C2 (if permeate from the permeate line 236). Although preferably positioned immediately downstream of the second three-way valve 242, the sensor 252 can be positioned anywhere along the exit line 246. In the preferred construction, the sensor 252 may be a conductivity sensor and/or total dissolved solids (e.g., TDS) sensor, but other types of sensors may be used to sense TDS concentration of the softened water line. The sensor 252 may be separately removable from the system 200, allowing the sensor 252 to be individually replaced in the event of damage.

The water hardness monitor system 228 permits the control system 400 to monitor and compare conductivity of the softened water and conductivity of the permeate to determine whether there has been breakthrough in the ion-exchange resin. The controller 410 performs the same analysis as discussed above with the first and second conductivity values C1, C2.

The brine supply line 244 communicates with the brine tank 240 and the ion-exchange reactor 216. More specifically, the brine supply line 244 delivers brine provided within the brine tank 240 to the ion-exchange reactor 216 when the ion-exchange resin needs to be regenerated. The valve 248 is in the supply line 244 downstream of the brine tank 240 and upstream of the ion-exchange reactor 216. The valve 248 is controlled by the controller 410 to open and close the supply line 244 to permit or prevent the flow of brine from the brine tank 240 to the ion-exchange resin.

With continued reference to FIG. 2, the mode of operation of the system 200 (in which the user draws water from the system 200 via the faucet 208) will now be described. The instant the faucet 208 is open, water moves from the water source 204 and through the ion-exchange reactor 216. Softened water flows toward the first three-way valve 226 via the softened water line 220. The flowmeter 224 determines the flow rate and/or volume of softened water passing through the flowmeter 224 and communicates the flow rate and/or volume to the controller 410. The controller 410 uses the flow rate and/or volume in order to monitor the brine tank 240, as will be later described with reference to FIG. 6. The first three-way valve 226 directs the flow of softened water into either the filtration line 230 or the bypass line 234. Softened water in the filtration line 230 flows into the nanofiltration module 256. Impurities caught in the upstream side of the nanofiltration module 256 are routed directly to the faucet 208 via the drain line 232. Permeate flows out the nanofiltration module 256 via the permeate line 236 toward the second three-way valve 242. Water directed into the bypass line 234 flows directly from the first three-way valve 226 to the second three-way valve 242. The controller 410 sends a signal to the second three-way valve 242 to allow the water to flow from the second three-way valve 242 toward the faucet 208. Additionally, the first sensor 252 determines the conductivity value of the water and stores the conductivity value as a first conductivity value C1 or a second conductivity value C2. The controller 410 uses the conductivity values C1, C2 in order to operate the brine tank 240, as will be later described with reference to FIG. 6. Based on the communication between the controller 410 and the brine tank 240, the controller 410 may open the valve 248 and actuate the brine tank 240 (e.g., opens communication between the tank 240 and the reactor 216), which permits the flow of brine from the brine tank 240 to the ion-exchange resin via the supply line 244. The permeate then continues along the permeate line 236 and exits the system 200 via the faucet 208.

FIG. 3 illustrates an alternative water softener system 300. The illustrated system 300 is similar to the systems 100, 200 described above and includes like parts. The system 300 differs from the systems 100, 200 in that it operates in different modes depending on if the water in the system 300 is being used for user consumption or for water hardness monitoring. Components that are similar to those described in the systems 100, 200 have the same reference number plus “300.”

The system 300 receives water (called “feed water”) from a water supply (e.g., a raw water supply) 304 which may be a municipal water supply, a well or any other typical source of potable water, and delivers clean, purified water to a potable water output device such as a faucet, or exit port, 308. The feed water may be provided under typical head pressures for water supply systems. The water supply 304 and faucet 308 are illustrated schematically and are intended to include any water inlet and any water outlet of the system 300.

The major components of the system 300 include: a feed line 312, a feed bypass line 314, an ion-exchange reactor 316, a softened water line 320, a flowmeter 324, a first solenoid valve 326, a second solenoid valve 342, an filtration line 330, a water hardness monitor system 328, a drain line 332, a permeate line 336, a check valve 350, a flow restrictor 354, a drain 338, a brine tank 340, a supply line 344, a valve 348, and the control system 400. The water hardness monitor system 328 includes a first sensor 352, a nanofiltration module 356, and a second sensor 360. The control system 400 includes the controller 410 and control logic to coordinate operation of the various other components. The specific control logic will be addressed after the following description of the major components.

The feed line 312 communicates between the water supply 304 and the ion-exchange reactor 316. The ion-exchange reactor 316 includes an upstream side communicating with the feed line 312 and a downstream side communicating with the softened water line 320. The ion-exchange reactor 316 includes an ion-exchange resin which removes impurities that contribute to water hardness, such as salts, small dissolved solids, or ions (e.g., calcium, magnesium), thereby creating softened water for the softened water line 320.

The second solenoid valve 342 is in the feed bypass line 314 downstream of the supply 304 and directs the flow of feed water to bypass the softening process. More specifically, the second solenoid valve 342 directs feed water to the water hardness monitor system 328 for raw water hardness measurement. In the illustrated embodiments, the second solenoid valve 342 is positioned in the feed bypass water line 314. The second solenoid valve 342 may direct the feed water to the filtration line 330, immediately downstream of the first solenoid valve 326. The second solenoid valve 342 is in communication with the controller 410. During water hardness measurement, the controller 410 emits a signal to the solenoid valve 342 to direct the flow of feed water into the feed bypass line 314. The water in the feed bypass line 314 is not used for user consumption, but rather only for water hardness monitoring. For example, the controller 410 may be timed to actuate the system 300 and direct the water through the feed bypass line 314 during long periods of non-operation (e.g., during the night). The controller 410 may also control the flow of water based on the alternative factors such as volume, flow rate, etc.

The softened water line 320 communicates with the downstream side of the ion-exchange reactor 316. The flowmeter 324 is in the softened water line 320 downstream of the reactor 316 and communicates (either via wires or wirelessly) with the controller 410 to monitor the flow rate and volume of the softened water. The flowmeter 324 may be positioned, for example, immediately downstream of the reactor and upstream of the faucet 308 as illustrated. In alternative configurations, the flowmeter 324 could be positioned anywhere along the softened water line 320. The flowmeter 324 may also be separately removable from the system 300, allowing the flowmeter 324 to be individually replaced in the event of damage.

The first solenoid valve 326 is in the filtration line 330 downstream of the flowmeter 324 and directs the flow of softened water. In the illustrated embodiments, the first solenoid valve 326 is positioned in the softened water line 320. The first solenoid valve 326 may direct the softened water through the filtration line 330. The first solenoid valve 326 is in communication with the controller 410. During water hardness measurement, the controller 410 emits a signal to the solenoid valve 326 to direct the flow of softened water into the filtration line 330. The water in the filtration line 330 is not used for user consumption, but rather only for water hardness monitoring. For example, the controller 410 may be timed to actuate the system 300 and direct the water through the filtration line 330 during long periods of non-operation (e.g., during the night). The controller 410 may also control the flow of water based on the alternative factors such as volume, flow rate, etc.

When the water hardness monitoring system 328 is not operating, softened water flows directly through the faucet 308 via the softened water line 320. When the water hardness monitoring system 328 is operating (e.g., when the controller 410 actuates the system), the softened water flows through the filtration line 330.

The first sensor 352 is in the filtration line 330 downstream of the first solenoid valve 326 and communicates with the controller 410 to monitor the impurities (e.g., total dissolved solids) in the filtration line 330. When the water passes through the first sensor 352, the first sensor 352 determines a first conductivity value C1 of the softened water and communicates (either via wires or wirelessly) the conductivity value C1 to the controller 410. Although preferably positioned immediately downstream of the ion-exchange reactor 316, the first sensor 352 can be positioned anywhere along the filtration line 330. In the preferred construction, the first sensor 352 may be a conductivity sensor and/or total dissolved solids (e.g., TDS) sensor, but other types of sensors may be used to sense TDS concentration of the softened water line 320. The first sensor 352 may be separately removable from the system 300, allowing the first sensor 352 to be individually replaced in the event of damage.

After passing through the first sensor 352, the softened water is directed to the nanofiltration module 356. The nanofiltration module 356 includes an upstream side communicating with the filtration line 330 and the drain line 332, and a downstream side communicating with the permeate line 336. The nanofiltration module 356 may remove remaining impurities in the softened water via a nanofiltration membrane. As a result, the water on the upstream side has a higher concentration of impurities and may be delivered directly to the drain 338 via the drain line 332. Alternatively, the water on the downstream side has a lower concentration of impurities and may be referred to as “permeate.” The permeate exits the nanofiltration module 356 via the permeate line 336 and is directed to the drain 338. The flow restrictor 354 is positioned in the drain line 332 to restrict the flow of water on the upstream side. This thereby creates backpressure against the nanofiltration module 356 and forces the permeate through the nanofiltration module 356. As the permeate flows from the nanofiltration module 356 to the drain 338, the permeate passes through the second sensor 360.

The second sensor 360 is in the permeate line 336 downstream of the nanofiltration module 356 and upstream of the drain 338. The second sensor 360 communicates with the controller 410 to monitor the impurities (e.g., total dissolved solids) of the permeate. The check valve 350 is positioned in the permeate line 336 to prevent water from flowing from the drain line 332 to the permeate line 336. The check valve 350 may additionally be a part of a multiport softener control valve, such as those manufactured by Hague Quality Water. When the water passes through the sensor 360, the sensor 360 determines a second conductivity value C2 of the permeate and communicates (either via wires or wirelessly) the second conductivity value C2 to the controller 410. Although preferably positioned immediately downstream of the nanofiltration module 356, the sensor 360 can be positioned anywhere along the permeate line 336. In the preferred construction, the sensor 360 may be a conductivity sensor and/or total dissolved solids (e.g., TDS) sensor, but other types of sensors may be used to sense TDS concentration of the softened water line. The sensor 360 may be separately removable from the system, allowing the sensor to be individually replaced in the event of damage.

As previously mentioned, the water hardness monitor system 328 includes the first sensor 352, the nanofiltration module 356, and the second sensor 360. The water hardness monitor system 328 monitors the breakthrough in the ion-exchange resin to determine an ion rate S of the nanofiltration module 356. More specifically, the first sensor 352 communicates the first conductivity value C1 to the controller 410 and the second sensor 360 communicates the second conductivity value C2 to the controller 410. As explained with respect to FIG. 1, the controller 410 then implements the first algorithm to determine the rejection rate S using the first and second conductivity values C1, C2.

The supply line 344 communicates with the brine tank 340 and the ion-exchange reactor 316. More specifically, the supply line 344 delivers brine provided within the brine tank 340 to the ion-exchange reactor 316 when the ion-exchange resin needs to be regenerated and/or recharged. The valve 348 is in the supply line 344 downstream of the brine tank 340 and upstream of the ion-exchange reactor 316. The valve 348 is controlled by the controller 410 to open and close the supply line 344 to permit or prevent the flow of brine from the brine tank 340 to the ion-exchange resin.

With continued reference to FIG. 3, the modes of operation of the system 300 will now be described. Specifically, the system 300 is operable in a first mode where the user actuates the system 300 by opening the faucet 308, and a second mode where the controller 410 automatically actuates the system 300 via a pre-set timing program or alternative algorithm. During the first mode of operation, the faucet 308 is opened and water moves from the water source 304 and through the ion-exchange reactor 316. Softened water flows toward the flowmeter 324 via the softened water line 320. The flowmeter 324 determines the flow rate and/or volume of softened water and communicates the value to the controller 410. The controller 410 uses the flow rate and/or volume value in order to monitor the brine tank 340, as will be later described with reference to FIG. 6. The first solenoid valve 326, which is downstream of the softened water line 320, is closed during the first mode of operation. Therefore, the controller 410 is not monitoring or collecting data on the system's conductivity values C1, C2.

During the second mode of operation, rather than directing the water to the faucet 308, the first solenoid valve 326 is open and directs the softened water toward the first sensor 352 via the filtration line 330. The first sensor 352 determines the first conductivity value C1 of the softened water and communicates the value C1 to the controller 410. The softened water then flows into the nanofiltration module 356. Impurities caught in the upstream side of the nanofiltration module 356 are routed directly to the drain 338 via the drain line 332. Permeate flows out the nanofiltration module 356 via the permeate line 336. The second sensor 360 determines the second conductivity value C2 of the permeate and communicates the value C2 to the controller 410. The controller 410 implements the first algorithm described with respect to FIG. 1 in order to determine an ion rejection rate S. The controller 410 uses the rejection rate S in order to operate the brine tank 340, as will be later described with reference to FIG. 5. Based on the communication between the controller 410 and the brine tank 340, the controller 410 may open or close the valve 348, which permits or prevents the flow of brine from the brine tank 340 to the ion-exchange resin via the supply line 344. The permeate then continues along the permeate line 336 and exits the system 300 via the drain 338.

During the second mode of operation, the controller 410 may emit a signal to open the second solenoid valve 342, thereby directing the feed water toward the filtration line 330. Once the feed water enters into the filtration line 330, the water travels through the water hardness monitor system 328, as described above. Similarly, the first and second sensors 352, 360 determine the first and second conductivity values C1, C2 and the controller 410 implements the first algorithm in order to determine an ion rejection rate S. The controller 410 may additionally implement alternative algorithms in order to measure the hardness of feed water.

As shown in FIG. 4, the control system 400 includes the controller 410 and an optional user interface 420. According to one or more exemplary constructions, the controller 410 includes a plurality of electrical and electronic components that provide power, operational control, and protection to the components and modules within the controller 410. For example, the controller 410 includes, among other things, an electronic processor 430 (e.g., a microprocessor, a microcontroller, or another suitable programmable device) and a memory 440. The controller 410 may communicate with various input units such as the first sensor 152, 252, 352, the second sensor 160, 260, the flowmeter 124, 224, 324, etc. and various output units such as the first solenoid valve 226, 326, the second solenoid valve 242, 342, the brine tank 140, 240, 340, the valve 148, 248, 348, etc.

The memory 440 includes, for example, a program storage area and a data storage area. In some constructions, the memory may be storage space in the cloud. The program storage area and the data storage area can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. With continued reference to FIG. 4, the electronic processor 430 is connected to the memory 440 and executes software instructions that are capable of being stored in RAM (e.g., during execution), ROM (e.g., on a generally permanent basis), or another non-transitory computer readable medium such as another memory or a disc. Software included in the implementation of the water hardness monitor system 128, 228, 328 can be stored in the memory 440 of the controller 410. The software includes, for example, firmware, one or more applications, program data, filters, rules, one or more program modules, and other executable instructions. The controller 410 retrieves from memory and executes, among other things, instructions related to the control processes and methods described herein. In other constructions, the controller 410 includes additional, fewer, or different components.

The optional user interface 420 may be used to control or monitor the water hardness monitor system 128, 228, 328. The user interface 420 includes a combination of digital and analog input or output devices required to achieve a desired level of control and monitoring for the hardness monitor system 128, 228, 328. For example, the user interface 420 includes a display (e.g., a primary display, a secondary display, etc.) and input devices such as touch-screen displays, a joystick, a plurality of knobs, dials, switches, buttons, etc. The display is, for example, a liquid crystal display (“LCD”), a light-emitting diode (“LED”) display, an organic LED (“OLED”) display, an electroluminescent display (“ELD”), a surface-conduction electron-emitter display (“SED”), a field emission display (“FED”), a thin-film transistor (“TFT”) LCD, etc. The user interface 420 can also be configured to display conditions or data associated with the water hardness monitor system 128, 228, 328 in real-time or substantially real-time. For example, the user interface 420 is configured to display measured electrical characteristics of the water hardness monitor system 128, 228, 328 and the status of the water hardness monitor system 128, 228, 328. In some implementations, the user interface 420 is controlled in conjunction with the one or more indicators (e.g., LEDs, speakers, etc.) to provide visual or auditory indications of the status or condition of the water hardness monitor system 128, 228, 328. The optional user interface 420 may be a smartphone running an application configured to communicate with the control system 400.

In some embodiments, the optional user interface 420 may display a color-coded qualitative hardness measurement. For example, a first color may indicate soft water (e.g., less than 17.1 ppm), a second color may indicate slightly soft water (e.g., between 17.1 and 60 ppm), a third color may indicate moderately soft water (e.g., 60-120 ppm), a fourth color may indicate hard water (e.g., 120-180 ppm), and a fifth color may indicate very hard water (e.g., greater than 180 ppm).

FIG. 5 illustrates a process 500 of automatically regenerating the ion-exchange resin for the system 100, 200, 300. The process 500 begins at step 510 wherein the ion-exchange resin is being regenerated. The controller 410 implements step 510 by opening the valve 148, 248, 348 (FIGS. 1-3) positioned between the brine tank 140, 240, 340 and the ion-exchange reactor 116, 216, 316, allowing brine (e.g., salt) to transfer into the ion-exchange resin. In step 320, the controller 410 monitors the hardness value H of the softened water using the water hardness monitoring system 128, 228, 328. In step 530 the controller 410 determines whether the hardness value H is less than a predetermined or threshold hardness value. The hardness value H is calculated using the ion rejection S determined via the controller 410. The controller 410 implements a second algorithm, shown below, to determine the hardness H using the first conductivity value C1, the second conductivity value C2, and the ion rejection rate S.

H(ppm)=aC₁²+bC₂²+cS²+dC₁C₂+eC₁S+fC₂S+gC₁+hC₂+iS+j

As previously stated, S is the ion rejection rate determined via the first algorithm. The variables a-j are constant values. As stated above, C1 represents the first conductivity value, as determined via the first sensor 152, 252, 352 in the system 100, 200, 300, and C2 represents the second conductivity value, as determined via the first sensor 252 or second sensor 160, 360 in the system 100, 200, 300.

Step 530 returns “True” if the hardness value H is less than the threshold and returns “False” if the hardness value H is equal to or greater than the threshold value. The threshold value for hardness in the example illustrated in the figures is 17.1 ppm. If step 530 returns “True” the logic moves to step 340 in which the controller 410 continues to monitor hardness at step 520. If step 530 returns “False” the logic moves to step 510 and the process starts over. In Step 510, the controller 410 automatically opens the valve 148, 248, 348 and actuates the brine tank 140, 240, 340, allowing brine from the brine tank 140, 240, 340 to regenerate the ion-exchange resin.

In the illustrated embodiment, the predetermined hardness value is 17.1 ppm. However, in alternative embodiments the predetermined hardness value may be an alternative hardness value. In the illustrated embodiment, the ion-exchange resin is automatically regenerated via the controller 410. In alternative embodiments, the controller 410 may alert the user that the ion-exchange resin needs to be regenerated via the user interface 420. The user may then manually open the valve 148, 248, 348 and actuate the brine tank 140, 240, 340 in order to regenerate the ion-exchange resin.

FIG. 6 displays a process 600 of determining when the brine tank 140, 240, 340 needs to be refilled with salt. Each time the brine tank 140, 240, 340 regenerates the ion-exchange resin, salt in the brine tank 140, 240, 340 is fractionally depleted. After multiple regeneration cycles, the brine tank 140, 240, 340 may become so depleted of salt that the brine solution is no longer saturated and the brine tank 140, 240, 340 needs to be manually refilled with brine. The process 600 begins at step 610 wherein the ion-exchange resin is new or has just been regenerated (e.g. with brine from the brine tank 140, 240, 340). In step 620, the controller 410 monitors the volume of softened water via the flowmeter 124, 224, 324. The controller 410 continuously monitors the volume, while also tracking the hardness using the process 500, as described with respect to FIG. 5. Once the controller 410 determines that the hardness value H of the softened water reaches or exceeds the threshold (e.g., 17.1 ppm) (step 530, FIG. 5), the controller 410 records the total volume of water which has passed the through flowmeter 124, 224, 324 up to this point. The controller 410 records this volume a first volume V1. In step 630, the controller 410 automatically opens the valve 148, 248, 348 and actuates the brine tank 140, 240, 340, allowing brine from the brine tank 140, 240, 340 to regenerate the ion-exchange brine.

In step 640, the controller 410 again monitors the volume of softened water via the flowmeter 124, 224, 324. The controller 410 continuously monitors the volume, while also monitoring the hardness using the process 500, as described with respect to FIG. 5. Once the controller 410 determines that the hardness of the softened water reaches or exceeds the threshold (e.g., 17.1 ppm) (step 530, FIG. 5), the controller 410 records the total volume of water which has passes through the flowmeter 124, 224, 324 up to this point. The controller 410 records this volume as a second volume V2.

In step 650, the controller 410 compares the second volume V2 to the first volume V1 to determine degradation of system performance (in terms of volume of softened water produced) following the regeneration in step 610 and the regeneration in step 630. If the volume of softened water produced following the regeneration in step 630 (i.e., the second volume V2) is less than or equal to a predetermined percentage of the volume of water produced following the regeneration in step 610 (i.e., the first volume V1), the controller 410 determines that cycle-to-cycle degradation in performance is severe. In such instance, the controller 410 causes a signal to be emitted on the user interface 420. An exemplary predetermined percentage which may indicate severe performance degradation is when the second volume V2 is less than or equal 70-90% of the first volume V1. Other predetermined percentages or ranges of percentages may be used depending on the system requirements. The predetermined percentage should be set at a lower end of what is acceptable effectiveness of the brine in regenerating the resin in the reactor 116, 216, 316.

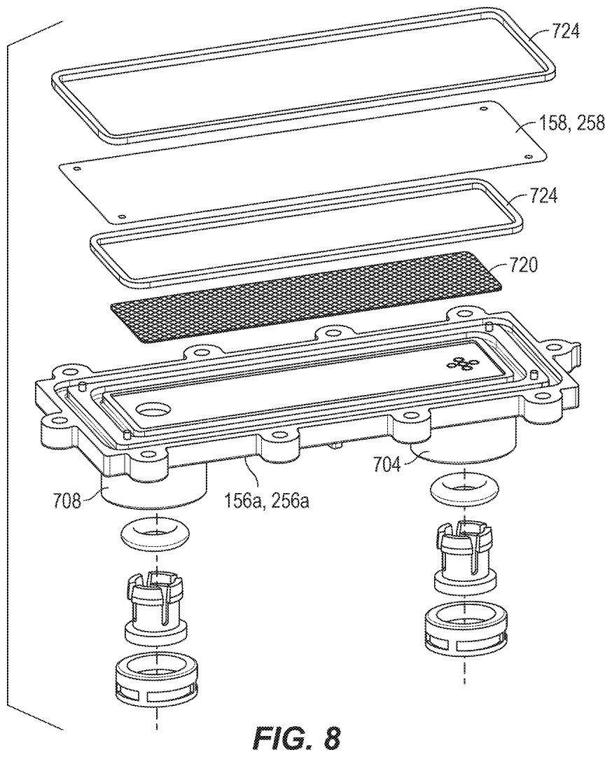

FIGS. 7-8 illustrate the nanofiltration module 156, 256, 356 which may be implemented in the systems 100, 200, 300. The nanofiltration module 156, 256, 356 is generally rectangular and includes a first portion 156a, 256a, 356a in communication with the softened water line 120 (system 100, FIG. 1) and/or the filtration line 230, 330 (systems 200, 300, FIGS. 2-3). The nanofiltration module 156, 256, 356 also includes a second portion 156b, 256b, 356a in communication with the permeate line 136, 236, 336. The first portion 156a, 256a, 356a includes a first port 704 configured to connect with the softened water line 120 and/or the filtration line 230, 330 and a second port 708 configured to connect with the drain line 132, 232, 332. The ports 704, 708 are generally cylindrical and include apertures 716 to receive and direct water into and/or out of the nanofiltration module 156, 256, 356. Specifically, softened water may enter the nanofiltration module 156, 256, 356 via the first port 704.

The second portion 156b, 256b, 356b of the nanofiltration module 156, 256, 356 includes a third port 712 configured to connect with the permeate line 136, 236, 336. The third port 712 is generally cylindrical and includes an aperture 716 to receive and direct water out of the nanofiltration module 156, 256, 356. Specifically, the nanofiltration module 156, 256, 356 directs permeate water out of the module 156, 256, 356 via the permeate line 136, 236, 336.

As shown in FIG. 8, the nanofiltration module 156, 256, 356 includes the nanofiltration membrane 158, 258, 358 positioned between the first and second portions 156a, 256a, 356a, 156b, 256b, 356b. The nanofiltration membrane 158, 258, 358 is a filter membrane configured to remove remaining impurities in the softened water. The membrane 158, 258, 358 may be constructed of polymeric and/or ceramic materials. The membrane 158, 258, 358 is surrounded by spacer sheets 720 and seals 724 in order to securely position the membrane 158, 258, 358 within the module 156, 256, 356. The module 156, 256, 356 further includes a plurality of fasteners 728 to secure the first portion 156a, 256a, 356a to the second portion 156b, 256b, 356b (FIG. 7).

Various features and advantages of the disclosure are set forth in the following claims.

What is claimed is:

1. A water softener regeneration system for a water softener configured to soften water, the regeneration system comprising:
a water hardness monitor system configured to determine a hardness value of water flowing out of the water softener;
a brine tank in communication with the water softener and operable to regenerate the water softener with brine from the brine tank; and
a controller operable to control the brine tank, wherein the controller actuates by one of opening and closing the brine tank based on the hardness value which is indicative of the effectiveness of the water softener.

2. The water softener regeneration system of claim 1, wherein the water softener includes an ion-exchange reactor having an ion-exchange resin.

3. The water softener regeneration system of claim 1, wherein the water hardness monitor system includes a sensor and a nanofiltration module.

4. The water softener regeneration system of claim 3, wherein the sensor is positioned downstream of the ion-exchange reactor.

5. The water softener regeneration system of claim 3, wherein the sensor is configured to determine a first conductivity value of water flowing out of the water softener and a second conductivity value of water flowing out of the nanofiltration module.

6. The water softener regeneration system of claim 1, wherein the water softener, the sensor, and the nanofiltration module are separately removable from the regeneration system.

7. The water softener regeneration system of claim 1, further comprising a flowmeter configured to determine a volume value of the water flowing into or out of the water softener.

8. The water softener regeneration system of claim 7, further comprising a user interface in communication with the controller, wherein the user interface is configured to display the hardness value of water flowing out of the water softener.

9. The water softener regeneration system of claim 8, wherein the user interface is configured to display a qualitative indicator indicative of a range of hardness values.

10. The water softener regeneration system of claim 8, wherein the user interface is configured to display an indicator indicative of the volume value in relation to a predetermined volume value.

11. A method for determining when a water softener configured to soften water needs to be regenerated, the method comprising:
operating the water softener to soften the water;
operating a sensor to measure a conductivity value of the water flowing out of the water softener;
operating a controller to implement an algorithm to determine a hardness value of the water in the water softener from the conductivity value;
operating the controller to compare the measured hardness value to a predetermined value; and
regenerating the water softener in response to a command from the controller when the measured hardness value exceeds the predetermined value.

12. The method of claim 11, further comprising operating a flowmeter configured to measure a volume of water softened by the water softener.

13. The method of claim 11, further comprising pre-calibrating the water hardness monitor system with water samples of varying hardness values to determine an algorithm for hardness measurement.

14. The method of claim 11, further including displaying the hardness value via a user interface.

15. The method of claim 11, further comprising positioning the sensor downstream of the water softener to measure the conductivity value of the water flowing out of the water softener.

16. A method for determining when a brine tank in communication with the water softener needs to be refilled, wherein the water softener is configured to soften and filter a water supply, the method comprising:
operating a flowmeter configured to measure a first volume of water softened by the water softener;
operating a sensor to measure a conductivity value of the water flowing out of the water softener;
operating a controller to determine a hardness value of the water flowing out of the water softener from the conductivity value;
comparing the measured hardness value to a predetermined hardness value;
operating the flowmeter to determine a first volume value of water softened prior to the measured hardness value exceeding the predetermined value;
after determining the first volume, regenerating the water softener;
after regenerating, operating the flowmeter to measure a second volume value of water softened after regeneration and prior to the measured hardness value exceeding the predetermined hardness value; and
refilling the brine tank with salt if the second volume value is less than a predetermined percentage of the first volume, and regenerating the water softener if the second volume value is not less than the predetermined percentage of the first volume value.

17. The method of claim 16, further comprising positioning the flowmeter is downstream of the water softener.

18. The method of claim 16, further comprising operating the controller to compare the first volume value to the second volume value.

19. The method of claim 16, wherein the predetermined percentage is with a range of 70% to 90% of the first volume.

20. The method of claim 16, further comprising displaying the first volume value and the second volume value on a user interface in connection with the controller.
